(19) United States
(12) Patent Application Publication
(10) Pub. No.: US 2017/0032290 A1
(43) Pub. Date: Feb. 2, 2017

(54) PERSONALIZED SHOPPING AND ROUTING

(71) Applicants: Rachel Louise Ford, Celina, TX (US); Gregory A. Ford, Plano, TX (US); Dan George Gonos, Folsom, CA (US)

(72) Inventors: Rachel Louise Ford, Celina, TX (US); Gregory A. Ford, Plano, TX (US); Dan George Gonos, Folsom, CA (US)

(21) Appl. No.: 15/104,800

(22) PCT Filed: Dec. 19, 2013
(86) PCT No.: PCT/US13/76436

§ 371 Date: Jun. 15, 2016

(51) Int. Cl. G06Q 10/04; G06Q 10/08; H04W 4/02

(52) U.S. Cl. CPC G06Q 10/047; H04W 4/021; G06Q 10/087

(57) ABSTRACT

Implementations of the present disclosure provide a method and system for personalized shopping and routing. According to one implementation, a list of desired items and travel parameters associated with a user are stored. Upon receiving a request for shop routing, the availability of the desired items at multiple retail locations is determined and a personalized travel route to purchase desired items is calculated based on geolocation data, inventory information, and the travel parameters. Lastly, the personalized route is provided for display to the user.

### BACKGROUND

Throughout each year, millions of people across the world visit retail establishments to purchase goods or services. Some large retailers carry hundreds to thousands of products to meet demand. During the holidays, many of these retailers offer large discounts on select items in an attempt to attract the most customers during these busy shopping seasons. Consequently, consumers must review hundreds of advertisements—either online, via target mail, or television commercials—in order to locate the best deal on a desired product. Sometimes consumers must endure waiting in abnormally long queues only to discover that the retailer is already sold out of a desired product. And in some instances, the user must travel long distances and thereby incur additional fuel costs in order to secure the best deal on a desired product.

### BRIEF DESCRIPTION OF THE DRAWINGS

The features and advantages of the present disclosure as well as additional features and advantages thereof will be more clearly understood hereinafter as a result of a detailed description of implementations when taken in conjunction with the following drawings in which:

FIG. 1 is a simplified conceptual diagram of a personalized shopping and routing system according to an example implementation.

FIG. 2 is a simplified block diagram of the personalized shopping and routing system according to an example implementation.

FIG. 3 is a sample illustration of the shopping list and inventory information used to facilitate personalized shopping routing according to an example implementation.

FIG. 4 illustrates a sequence diagram of the processing steps for personalized shopping and routing according to an example implementation.

FIG. 5 illustrates a simplified flow chart of the processing steps for providing personalized shopping and routing according to an example implementation.

FIG. 6 illustrates another simplified flow chart of the processing steps for providing personalized shopping and routing according to an example implementation.

### DETAILED DESCRIPTION OF THE INVENTION

The following discussion is directed to various examples. Although one or more of these examples may be discussed in detail, the implementations disclosed should not be interpreted, or otherwise used, as limiting the scope of the disclosure, including the claims. In addition, one skilled in the art will understand that the following description has broad application, and the discussion of any implementations is meant only to be an example of one implementation, and not intended to intimate that the scope of the disclosure, including the claims, is limited to that implementation. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

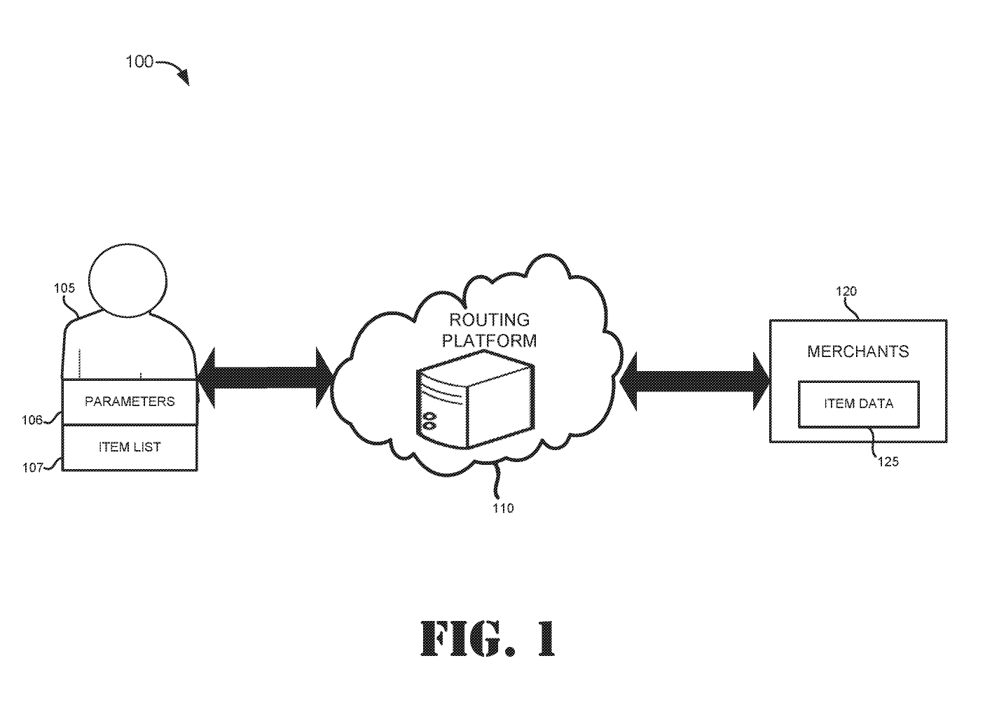

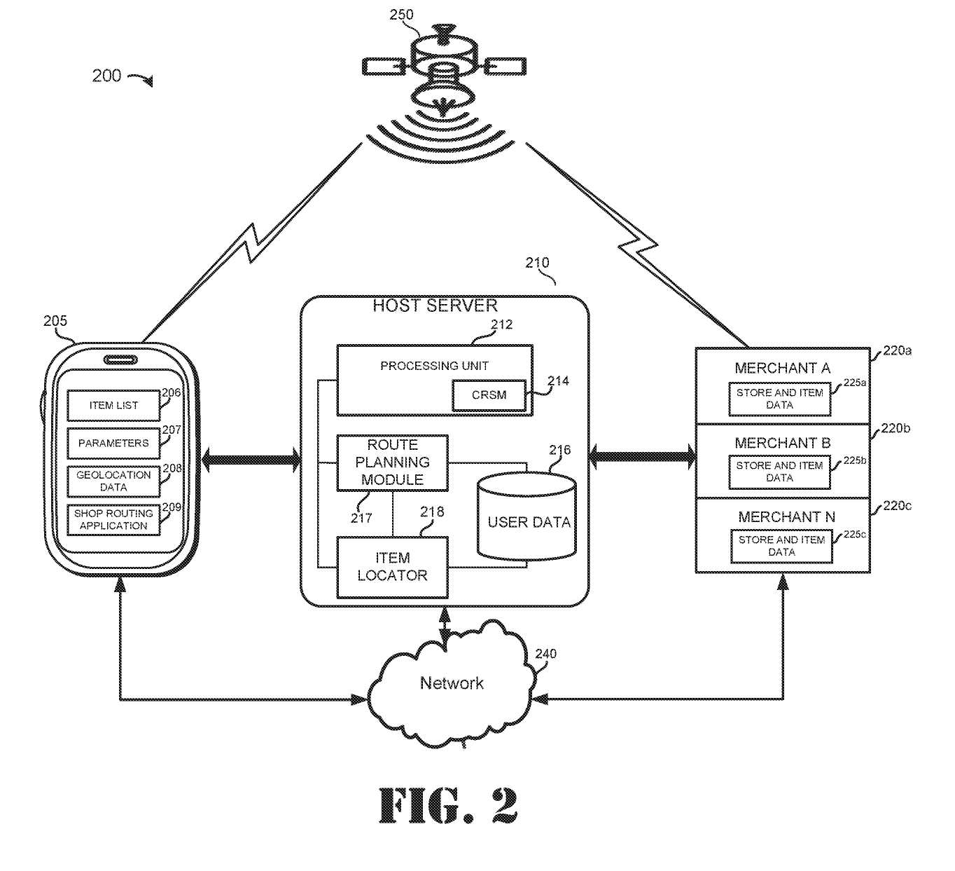

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Prior attempts to simplify the shopping experience include individual checkout systems that work only for that particular store. Other retailers have incorporated near field communication (NFC) and other wireless technologies as a means to allow customers to purchase items using their mobile phone and without interacting with a sales person. However, these solutions do not take into consideration purchases made at multiple store locations and locating a plurality of items amongst different retailers prior to shopping.

Examples of the present invention provide a solution that interacts with store inventory databases and provide users with routing information on where items can be purchased. According to one example, the system described herein provides the user with one or more personalized ‘routes’ to shop for their desired items. Moreover, various filters or parameters may be established by an operating user to enable further customization of the shopping route(s).

Referring now in more detail to the drawings in which like numerals identify corresponding parts throughout the views, FIG. 1 is a simplified conceptual diagram of a personalized shopping and routing system according to an example implementation. As shown in the present example, the system 100 includes a user 105 and merchant system 120 in communication with a host server 110 over a network.

User 105 represents an individual operating a computing device capable of communicating with the host server 110. According to one implementation, the user 105 designates a shopping list of items to be purchased along with parameters associated with acquiring the desired items. For example, the parameters may include a maximum price for an item, distance traveled, fuel consumption, number of stops, lowest combined cost, mode of transportation, route within a store, lowest total purchase, lowest mileage, lowest time to complete route, and the like.

Merchants 120 represent a plurality of retail stores and associated databases, which include item inventory data for products being sold in the respective stores. For example, the item inventory data may include any data that aids in making a routing or purchasing decision such as the available quantity of a particular item, pricing information, purchase rate/history, size, brand, price point, expected shipment data, as well as item location within the store for allowing customers to better plan their shopping experience or to build a shopping route within the store. According to one implementation, merchants 110 represent at least two disparate and unaffiliated retailers that sell goods or services of interest to the user.

Furthermore, routing server 110 represents a host service provider configured to pull item inventory data from a merchant and provide personalized routing information to a requesting user. More particularly, and as will be described in further detail with reference to figures below, the host server 110 may receive a routing request from user 105 and determine an optimized shopping route for each of the items based on the user parameters and item inventory data associated with merchants 120.

Implementations described herein serves to reduce user shopping time, overall purchase cost, travel time, and forgotten items while simplifying the shopping experience. For example, if a user is on a vacation with their family and needs to acquire milk, bread, lunch meat, drinks, sunscreen, beach towels and diapers, the user may enter these as desired items within their shopping list and system will provide an optimum route for purchasing the desired items based on preset user preferences or parameters and merchant inventory data as will be descried in further detail with reference to figures below.

FIG. 2 is a simplified block diagram of the personalized shopping and routing system according to an example implementation. Here, the system 200 includes a user computing device 205, host server 210, and merchants 220a-220c. In one example, the computing device 205 stores user information including an item list 206, user parameters 207, geolocation data 208 via GPS satellite 250, and a shop routing application 209 associated with the routing host server 210 and installed on memory of the computing device 205. According to one implementation, when the user requests a personalized shopping route from the host server 210 via the shop routing application 209, the item listing 206, parameters 207, and geolocation data 208 are sent to the host server over a communication network. As mentioned earlier, the item list 206 represents an enumerated listing of one or more items desired for purchase by the user, while the parameters 207 represent travel (e.g., minimum stops) and item preferences (e.g., less than a specific dollar amount) utilized by the host server 210 for determining one or more optimum routing options. Still further, geolocation data 208 is utilized by the host routing server to determine the approximate location of the user device 205 and corresponding nearby retailers 220a-220c for the purchase of desired goods.

Merchant systems 220a-220c represent a plurality of retailers offering for sale products or services corresponding with items on the user's shopping list. Each merchant system 220a-220c includes store and item inventory data 225a-225c such as the geographic location (e.g., longitude and latitude data) of the associated retailer and the available quantity and/or purchase rate of an item respectively. Store and item data 225a-225c may be stored on a merchant system database and transmitted to the routing host 210 upon request, or automatically at predetermined intervals (e.g., inventory data sent to the host server 210 hourly).

Routing service provider 210 represents a computing architecture having at least one computer system or host server, which may be operational with numerous other general purpose or special purpose computing system environments or configurations and may include, but is not limited to, personal computer systems, server computer systems, mainframe computer systems, laptop devices, multiprocessor systems, microprocessor-based systems, network personal computers, and distributed cloud computing environments that include any of the above systems or devices, and the like. Moreover, the host server provider system 210 and merchant systems 220a-220c may be described in the general context of computer system-executable instructions stored on a computer readable storage, such as program modules, being executed by a computer system. Also, the host server or service provider 210 further includes a processing unit 212, route planning module 217, item locator 218, and user profile data 216.

Processor 207 may be, at least one central processing unit (CPU), at least one semiconductor-based microprocessor, at least one graphics processing unit (GPU), other hardware devices suitable for retrieval and execution of instructions stored in machine-readable storage medium 214, or combinations thereof. For example, the processor 212 may include multiple cores on a chip, include multiple cores across multiple chips, multiple cores across multiple devices, or combinations thereof. Processor 212 may fetch, decode, and execute instructions to implement the approaches of the multi-currency payment system. As an alternative or in addition to retrieving and executing instructions, processor 212 may include at least one integrated circuit (IC), other control logic, other electronic circuits, or combinations thereof that include a number of electronic components for performing the requisite functionality.

Machine-readable storage medium 214 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 214 may be encoded with a series of executable instructions for determining personalized shop routing options.

In one implementation, the user profile database 216 includes information pertaining to a registered user account. For example, user profile data may include a list of desired items and shopping or travel preferences (i.e., parameters) associated with a particular user. The user profile data 216 may be continually maintained either by the user through networked access to the host server 210 and manually updating the item list or parameters, or automatically as purchases are made on the user account (e.g., linked bank account and purchasing history).

Item locator 216 communicates with a plurality of retailer databases (e.g., merchants 220a-220c) to retrieve item inventory data for desired items associated with a requesting user's shopping list. According to one example, the item locator 216 may be utilized by the processing unit to pull (e.g., via online sources) real-time (e.g., at the time of the routing request) inventory data from a plurality of relevant retailers. For instance, the item locator 116 may retrieve the remaining quantity, price, and the purchase rate for a particular item at a relevant retailer (i.e., merchant selling desired product). Once the item inventory data is retrieved, the route planning module 217 includes instructions for determining an optimum route to one or more retail stores for purchasing the desired items associated with the requesting user. According to one implementation, the item locator 216 and route planning module 217 may be incorporated together as one module and within the storage medium 214.

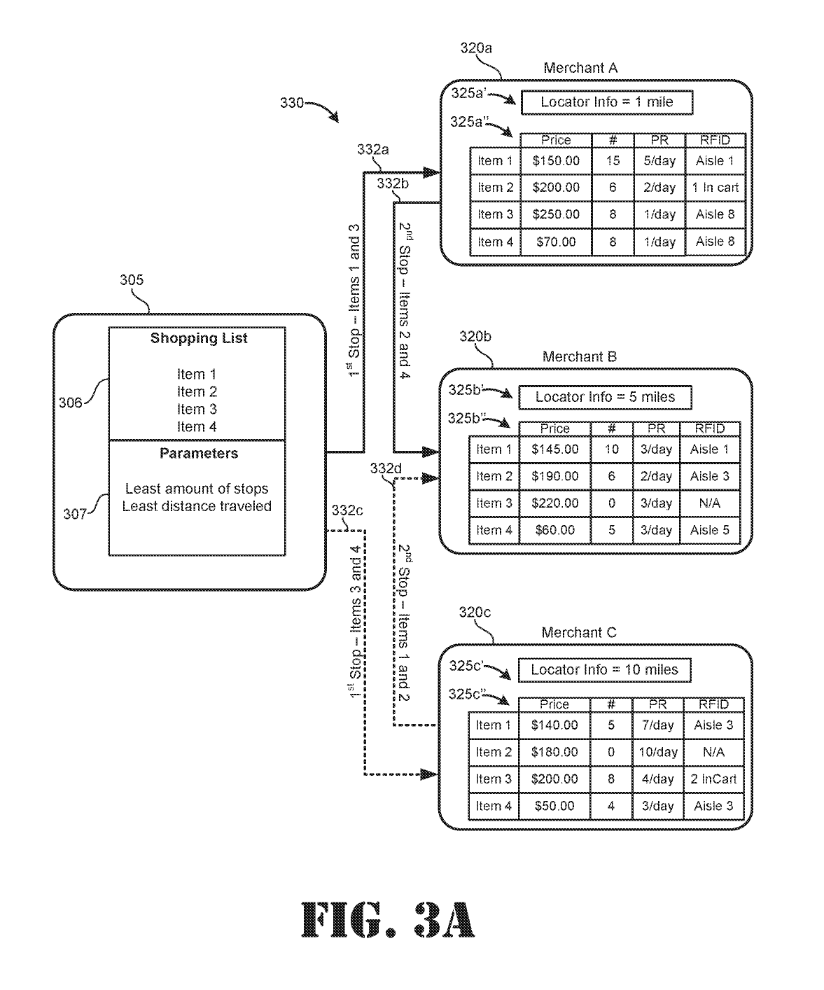

FIG. 3 is a sample illustration of the shopping list and inventory information according to an example implementation. As mentioned above, the user device 305 may include a shopping list 306 and one or more parameters 307. Here, the shopping list includes items 1-4, while the parameters include preferences for a route having “the least number of stops” and “least distance traveled”. Each merchant system 320a and 320c includes location data 325a′-325c′ and item inventory data 325a″-325c″. More particularly, the location information 325a′ represents a geographic location of the retail store, which the routing system uses to compute the distance from the user 305 to a particular store (e.g., 320a-320b). In the present example, the item inventory information 325a″-325c″ includes the price of the item, available quantity of an item for purchase, the purchase rate of the item within a particular timeframe (i.e., one day), and transient or sub-location information of an item within the store (e.g., via ID tags).

In the scenario presented in FIG. 3, “Merchant A” may represent a high-end boutique store, “Merchant B” may represent a large big-box retailer (e.g., Target®), while “Merchant C” represents a large wholesale store. Based on the parameters designated by the user along with the item inventory data, the shopping and routing system may determine that items 1 and 3 can purchased with high confidence (given the purchase rate) from nearby Merchant A (320a). Furthermore, the system may determine that items 2 and 4 are being sold for less at “Merchant B” (320b), and also that the additional cost in fuel consumption to travel four miles from “Merchant A” and “Merchant B” is outweighed by the $20 cost-savings in purchasing the items at “Merchant B”. As such, an optimum route 330 may be calculated and presented that instructs the user to travel along path 332a to “Merchant A” in order to purchase items 1 and 3, and then along path 332b in order to purchase items 2 and 4 from “Merchant B”. The routing and path data may be displayed on the user's computing device as a list view of directions along each path, or as a graphical mapping image with highlighted routing options. The system may also include a notification with the routing information that the purchase should take place in the next twenty-four hours due to the current purchase rate of items (e.g., item 4 from Merchant B may be sold out after twenty-four hours).

In another example scenario, the user may set a parameter for the “least expensive total cost”. In such an example, and using the item inventory data of FIG. 3, the shopping and routing system may determine that—due to the cost-savings and distance—the user should elect to purchase items 1 and 2 from Merchant B (320b) and items 3 and 4 from “Merchant C” (320c) as indicated by the dotted lines (paths 332c and 332d). Moreover, the purchase rate/history of products (e.g., item 4 from Merchant C) may be taken into consideration such that the system presents a personalized and optimized route for the user to travel to the longer path to “Merchant C” for purchasing items 3 and 4 prior to purchasing items 1 and 2 from the nearer “Merchant B”. This is but one example as the system may consider several factors in determining an optimized route. For example, in the event the user's parameters include places of interests (e.g., near gas station, restaurants, church, etc.), the system may provide a routing paths to merchants or retailers that satisfy the most parameters designated by the operating user.

In accordance with one example implementation, the system may utilize wireless data transfer devices such as Radio Frequency Identification (RFID) tags located on store inventory in order for retailers to track items and have more accurate inventory information of items within the store (i.e., sub-location data). For example, the user of RFID tags will allow merchants to ascertain not only what has already been purchased, but also what is expected to be purchased because an item may currently be within a customer's active shopping cart within in the store. Such a configuration allows stores to provide more accurate information on current inventory through the online shopping list preparation, as well as better track where high-loss items are in the store in attempt to reduce theft. In one implementation, retrieval of the merchant inventory information includes updating the inventory information for a desired item based the current available quantity and the sublocation data of the item. For instance, merchant information may state that the store has two items available for purchase (i.e., available quantity), but both of the available items may be in one's shopping cart within the store (sublocation data) and therefore likely to be unavailable for purchase by the requesting user. Thus, providing real-time inventory information that is updated based on sublocation information serves to provide users with the most up-to-date inventory information for a desired item.

Moreover, once items have been selected, automated checkout can be accomplished at a particular store as RFID tags may be used to track which items are in the cart. In one example, a separate exit lane can be used whereby the user crosses a sensor path that activates a collection of the RFID tag readers in the field and creates a checkout for the shopper. The user may also elect to store payment information in the system in which case a PIN may be required during checkout to avoid incorrectly preparing a checkout or picking up items that are in another customer's shopping cart. The system may capture the RFID tags in the field and effect payment through regular online payment methods (e.g., SSL, etc.).

In addition to inventory information, the system may provide additional purchasing data to the shopper such as prices, recommendations for alternate items in addition to online coupon for desired items. Still further implementations include the ability to create paths through the retail store, pre-selection of low-level inventory and/or during sales, ability to have items pulled for the customer and shopping bags prepared, store brand discounts to increase volumes, and the like.

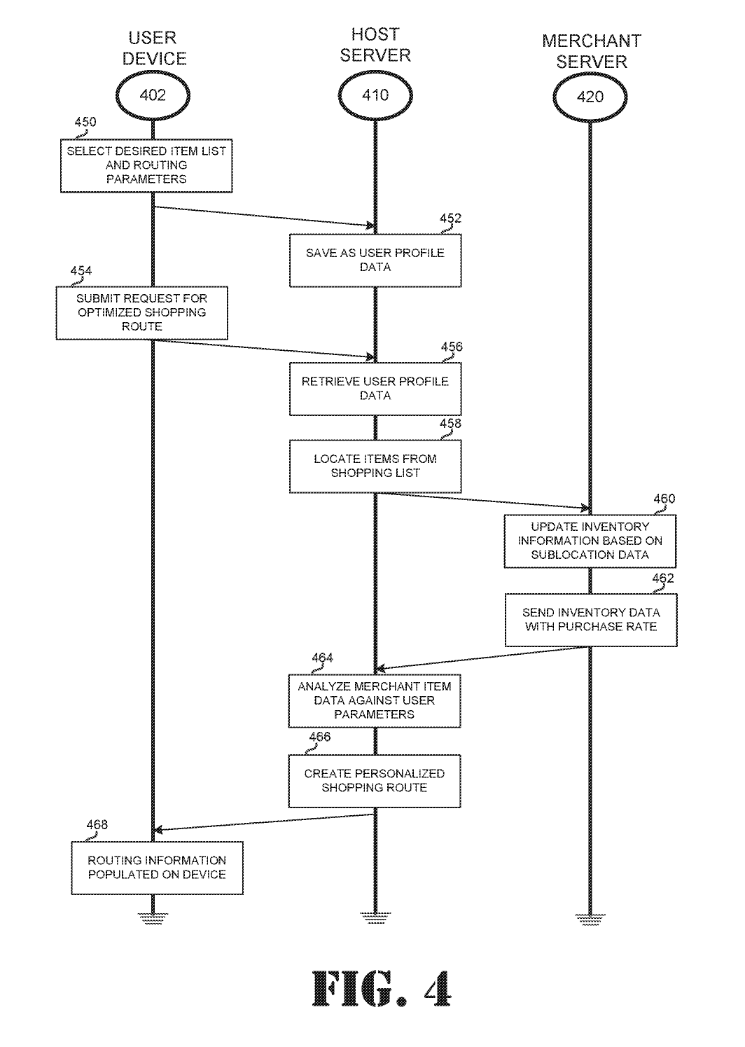

FIG. 4 illustrates a sequence diagram of the processing steps for personalized shopping and routing according to an example implementation. In segment 450, a user operating a computing device 402 selects one or more items desired to be purchased in addition to routing preferences or parameters for making the purchase. This data may be saved as user profile data on the host routing server 410 in segment 452. Furthermore, when the user submits a request for an optimized routing option in segment 454, then in segment 456, the host routing server 410 retrieves the user profile data (e.g., desired product list and parameters) from the user profile database or directly from the device 410 via the personalizing shopping application running on the client device 410. In segment 458, the desired items form the shopping list are cross-referenced with the item inventory data from one or more merchant servers 420.

In segments 460, the merchant inventory information for one or more desired item is updated by the merchant system 420 based on the available quantity and sublocation data (e.g., via RFID tags) associated with the item so that the most recent availability information can be utilized in the calculation of the optimized route for the user. In segment 462, the merchant server 420 sends the latest item inventory data along with current pricing and purchase history of the desired item(s) to the host routing server 410. Next, in segment 464, the item inventory data is analyzed against the user parameters and shopping list. Based on the system analysis, the host routing server 410 creates one or more personalized shopping routes in segment 466. The personalized shopping route may be optimized such that the user is has the highest possible chance of acquiring each item on the list within the travel parameters designated by the user and within a specific timeframe. For instance, the system described herein may determine that the requesting user has the highest possible chance of obtaining multiple desired items from nearby stores A and B within the next forty-eight hours, and also computes preferred routing options to travel to each store location from a designated starting position (e.g., geolocation of computing device or starting address input by user). Lastly, one or more personalized shopping routes are then presented for display on the computing device 402 of the user (e.g., via installed shop routing application).

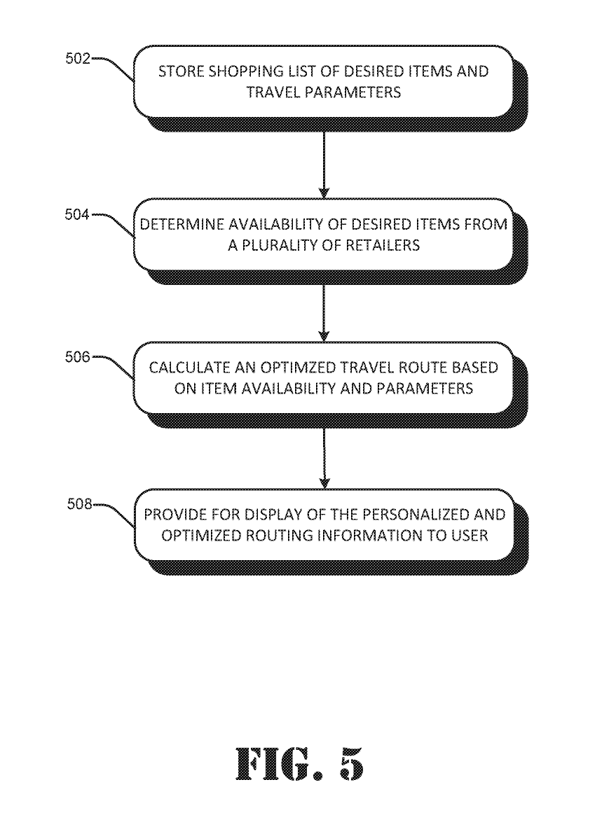

FIG. 5 illustrates is a simplified flow chart of the processing steps for providing personalized shopping and routing according to an example implementation. In block 502, the host server and processing unit receive user profile date including a shopping list of desired items in addition to one more travel parameters. The processing unit and item locator module are configured to determine the availability of the desired items from a plurality of retailers in block 504. Next, in block 506, the host server and routing module retrieve the item inventory data from the relevant merchants and calculate an optimized travel route to purchase desired items based on item data and user parameters. In one implementation, a purchase confidence factor is computed for an individual item based on the item quantity and the purchase rate of a select item at a particular store location. For example, if there are only four items remaining for purchase, but the purchase history indicates that a particular item has been selling at four units per day at an identified retailer, then the system may determine a lower purchase confidence factor for that item at the associated store, particularly within the next twenty-four hours. According to one implementation, items and retailers having the highest confidence factors are considered for personal routing. In block 508, the host server transmits optimized routing instructions to the client device for view or selection by an operating user.

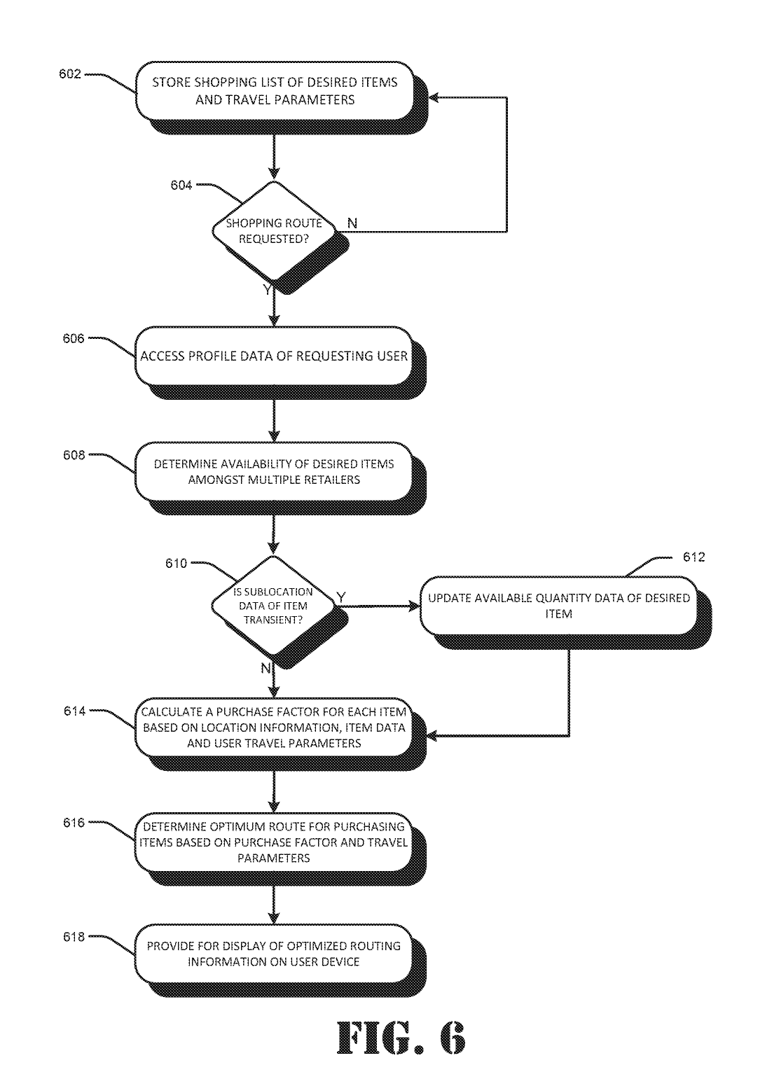

FIG. 6 illustrates another simplified flow chart of the processing steps for providing personalized shopping and routing according to one implementation. Initially, the user establishes a shopping list of desired items and travel parameters in block 602. The item list may be assigned on the computing device operated by a user via an installed routing application associated with the host server, or the item list may be input directly into a website associated with the host routing server. Upon receiving a routing request from the operating user in block 604, the user profile data associated with the requested user is accessed from the profile database or user device by the host server in block 606. Thereafter, the host routing server determines the availability of the desired items amongst a plurality of retailers within the geographic area of the user in block 608. For instance, the item locator may select for consideration the five closest retailers offering one or more of the desired items for sale. In block 610, confirmation of the availability of a desired item at each store is made by the host server or merchant system determining whether the sublocation data of an item is transient (e.g., location of item is moving and likely within another customer's shopping cart). If a determination is made that the sublocation data is transient or varies from its previous sublocation data (e.g., previously aisle 3 and now in check-out aisle), then the merchant inventory information for the desired item is updated so that the number of desired items having transient sublocation data are removed from the available quantity count in block 612.

In block 614, a purchase confidence factor is computed for each item based on the location information, item inventory data and the user travel parameters. In one implementation, the purchase confidence factor represents the quantity of the items available for purchase divided by the purchase rate over a specific time period. For example, a first store presently carrying 10 personal computers (a desired item from the user's shopping list) but having a purchase rate of 20 units per week for the past month may be assigned a confidence factor of 0.05, while the same item at a second store carrying 8 personal computers yet only averages 4 units sold per week would be assigned a confidence factor of 2. Though the first store has more units available, the system of the present disclosure may determine that the customer may have higher probability of purchasing the desired item at the second store. However, the purchase confidence factor is one variable in computing the personalized route as the user parameters, distance to the retailer, and price may all be used in determining the optimized route of travel. Next, in block 616, a personalized and optimum travel route for purchasing one or more desired items is determined based on the identified retailers and the travel/purchase parameters designated by the user. Lastly, the processing unit provides instructions for presenting the optimized routing information on the operating device of the user in block 618. The routing information may include only one optimized route or several personalized routing options for selection by the user.

Implementations of the present disclosure provide a system and method for providing personalized shopping and routing. Moreover, many advantages are afforded by the implementations of the present disclosure. For instance, providing a customized shop routing option saves the user considerable amount of time and money, particularly fuel consumption, when shopping for high-demand items during busy shopping seasons. Furthermore, the personalized shopping and routing system of the present disclosures enables the user to quickly and easily leverage the store's inventory information to ascertain the most up to date stocking numbers, location within the store, and the likelihood the item may still be available for purchase within a predetermined time period.

Moreover, utilization of sub-location data (e.g., RFID tags) gives retailers more control of their inventory, reduces the likelihood of theft, and can also help to increase sales due to a reduced time to check-out. For merchant systems, sales can also be improved through product placement in the store based upon an identified traffic pattern and also suggesting complimentary items and/or substitutes when a shopper's desired items are not available. In addition, the present configuration allows for better inventory management and maximum sales as it enables retailers to understand what local customers are purchasing compared with what items are being purchased by visitors/travelers that do not normally shop at the particular store.

Furthermore, while the disclosure has been described with respect to particular examples, one skilled in the art will recognize that numerous modifications are possible. Moreover, not all components, features, structures, characteristics, etc. described and illustrated herein need be included in a particular example or implementation. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some examples have been described in reference to particular implementations, other implementations are possible according to some examples. Additionally, the arrangement o order of elements or other features illustrated in the drawings or described herein need not be arranged in the particular way illustrated and described. Many other arrangements are possible according to some examples.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

1. A method for personalized shopping comprising:
storing a listing of desired items and travel parameters associated with a user;
determining, upon receiving a personalized routing request from a user, the availability of the desired items at a plurality of retail locations based on merchant inventory information including, for at least a given one of the items, an available quantity of the given item and a purchase history associated with the given item;
calculating a personalized travel route to purchase a plurality of desired items based on geolocation data of the user, merchant inventory information, and the travel parameters; and
providing for display of the personalized travel route to the user.

2. The method of claim 1, further comprising:
retrieving merchant inventory information of at least the given item from a corresponding retailer; and
calculating a purchase confidence factor for the at least the given item based on the available quantity and purchase history.

3. The method of claim 1, further comprising:
for each of the items, calculating a purchase confidence factor based on an available quantity and a purchase history for the item; and
determining at least one optimized routing option for the user based on the respective purchase confidence factors associated with the items and the travel parameters.

4. The method of claim 3, further comprising:
determining an internal route within a retail store based on sublocation data associated with one or more of the desired items.

5. The method of claim 1, further comprising:
receiving a request for shop routing via an application running on a mobile device associated with a user;
retrieving the desired item list and travel parameters from the mobile device associated with the requesting user; and
presenting a plurality of preferred routing options for the desired items based on a purchase confidence factor of each item and geolocation data associated with the retailer and said mobile device.

6. The method of claim 1, wherein the merchant inventory information from each retailer includes an item quantity, item price, item purchase rate within a predetermined time period, and sublocation data of an item within a store associated with the retailer.

7. The method of claim 1, further comprising, retrieving the merchant inventory information in real-time such that the merchant inventory information for at least the given one of the items is adjusted based on sublocation data and the available quantity.

8. A personalized shopping and routing system comprising:
a user profile database configured to store a desired item listing along with travel parameters for purchasing said desired items; and
a host server to determine the availability of the desired items at a plurality of retail locations based on merchant inventory information, wherein the server is to calculate a personalized travel route to purchase the desired items based on geolocation data associated with the user, the travel parameters, and said merchant inventory information,
wherein said merchant inventory information includes an available quantity and purchase history for each of the desired items;
wherein the host server is to change an available quantity count for one of the items at a given store based on a sublocation of an instance of the item at the given store being transient or varying from a previous sublocation; and
wherein the personalized route is provided for presentation on a computing device associated with a user upon request for shop routing from the user.

9. The system of claim 8, wherein the host server is to retrieve said merchant inventory information from a corresponding retailer, wherein the retrieved merchant inventory information is associated with at least one of the desired items and includes an available quantity and purchase history associated with each of the at least one desired item for with the corresponding retailer.

10. The system of claim 9, wherein the host server is to calculate a purchase confidence factor for the at least one desired item based on the available quantity and purchase history.

11. The system of claim 10, wherein at least one routing option is determined based on the purchase confidence factor associated with each of the at least one desired item and the travel parameters.

12. The system of claim 10, wherein:
the list of desired items and travel parameters are retrieved from an application running on a mobile device associated with the requesting user upon receiving a request for shop routing; and
a plurality of preferred routing options for the desired items are provided for presentation at the mobile device based on the purchase confidence factor of each item and geolocation data associated with the retailer and said mobile device.

13. The system of claim 9, wherein the merchant inventory information from each retailer includes an item quantity, item price, and item purchase rate within a predetermined time period, and sublocation data for the item within a store associated with the retailer.

14. A non-transitory computer readable storage medium for personalized shopping and routing having stored executable instructions, that when executed by a processor, cause the processor to:
store a list of desired items and travel parameters associated with a user;
retrieve inventory data associated with at least one of the desired items from a corresponding retailer, wherein the inventory data includes an available quantity and purchase history associated with the at least one desired item;
calculate a purchase factor for the at least one desired item based on the available quantity and purchase history;
determine at least one routing option for presentation to the user based on the purchase factor associated with each of the desired items, geolocation data of a computing device, and the travel parameters; and
provide routing information based on the at least one routing option to the computing device for presentation on the computing device.

15. (canceled)
